(19) United States
(12) Patent Application Publication
(10) Pub. No.: US 2021/0108721 A1
(43) Pub. Date: Apr. 15, 2021

(54) RELEASE DEVICE FOR A VEHICLE

(71) Applicant: ZF Friedrichshafen AG, Friedrichshafen (DE)

(72) Inventors: Carsten Bode, Diepholz (DE); Joachim Spratte, Osnabrueck (DE); Torsten Aumann, Drentwede (DE); Frank Plesternings, Barver (DE); Angela Squeri, Oberteuringen (DE); Martin Herrmann, Friedrichshafen (DE); Daniel Pfeiffer, Berg (DE)

(73) Assignee: ZF Friedrichshafen AG, Friedrichshafen (DE)

(21) Appl. No.: 16/463,663

(22) PCT Filed: Oct. 23, 2017
(86) PCT No.: PCT/EP2017/076952

§ 371 Date: May 23, 2019

(51) Int. Cl. F16H 63/34; G01B 7/14

(52) U.S. Cl. CPC F16H 63/3491; G01B 7/14

(57) ABSTRACT

The present approach relates to a release device (105) for a vehicle (100) for detecting at least one position of a drive unit (106) in, or in the vicinity of, a slide unit (108). The release device (105) comprises at least the drive unit (106), the slide unit (108), and a sensor system (109). The drive unit (106) is or can be located at least partially in the slide unit (108) of the release device (105) in a first position, in order to lock or engage a parking lock (110) of the vehicle (100), and at least partially removed form the slide unit (108) in a second position, in order to release or disengage the parking lock (110). The slide unit (108) is configured to at least partially receive the drive unit (106) in at least the first position of the drive unit (106). The sensor system (109) has at least one drive sensor system (160) located on the drive unit (106), and/or one slide sensor system (165) located on the slide unit (108), wherein the sensor system (109) is configured to detect the position of the drive unit received in slide unit (108) or located in the vicinity of the slide unit (108).

The present approach relates to a release device for a vehicle, for detecting at least one position of a drive unit in, or in the vicinity of, a slide unit, and a method for registering at least one position of a drive unit in, or in the vicinity of, a slide unit of a release device in a vehicle.

If a gear selection lever in the automatic transmission of a vehicle is at “P,” a parking lock is engaged, and prevents a vehicle from rolling away. The parking lock can be activated by the gear selection lever via a cable pull. With some automatic transmissions, the engagement and disengagement takes place via an internal hydraulic servo control. With some transmissions, the actuation also takes place via electric motors. With these, an electric motor actuates the parking lock via a transmission, and thus secures the vehicle against rolling away, or releases it.

Based on this, the present approach results in an improved release device for a vehicle, for detecting at least one position of a drive unit in, or in the vicinity of, a slide unit, and an improved method for registering at least one position of a drive unit in, or in the vicinity of, a slide unit of a release device in a vehicle according to the independent claims. Advantageous embodiments can be derived from the dependent claims and the following description.

According to the approach presented herein, a release device for a vehicle, for detecting at least one position of a drive unit in, or in the vicinity of, a slide unit comprises at least the drive unit, the slide unit, and a sensor system. The drive unit is or can be located at least partially in the slide unit of the release device in a first position, in order to lock a parking lock of the vehicle, and is at least partially moved out of the slide unit in a second position, in order to release the parking lock. The drive unit can be in the form of an eccentric element, or a gearwheel that moves along an inner surface of the slide unit. The slide unit is designed to at least partially receive the drive unit, at least in the first position. The drive unit, or a portion of the drive unit, can be completely received in the slide unit in the first position, for example, and partially moved out of the slide unit in the second position, or the drive unit, or a portion of the drive unit, can be only partially received in the slide unit in the first position, and entirely removed from the slide unit in the second position. The sensor system has at least one drive sensor system on the drive unit, and/or one slide sensor system on the slide unit, wherein the sensor system is configured to detect the position of the drive unit received in the slide unit, or located in the vicinity of the slide unit.

The release device presented herein enables the detection of at least one position of a drive unit in a slide unit by the sensor system, such that it can then be concluded whether a parking lock in the vehicle is locked or released. The position can represent the second position of the drive unit, in order to be able to identify a released parking lock by detecting the position.

The sensor system can be configured to compare a position of a drive sensor in the drive sensor system and/or a position of a slide sensor in the slide sensor system, in order to detect the position. This can then be enabled when the drive sensor position is assigned to a slide sensor position, in particular wherein the position can be detected when the drive sensor position is not located in a predefined relationship to the dedicated slide sensor position. By way of example, a drive sensor position R1 can be assigned to a slide sensor position R, which corresponds to a position of a gear selection lever in the vehicle in a gear R. The drive sensor position R1 can be located in the vicinity of the first position of the drive unit in this case. The drive sensor position is thus not located in the predefined relationship to the slide sensor position when the drive unit is moved to the second position. In this manner, it can be quickly and easily detected that the parking lock has been released by the release device.

The drive sensor system can have numerous drive sensors, which can be arranged in a curve, e.g. on a section of the drive unit, and/or the slide sensor system can have numerous slide sensors in a linear arrangement. A curved arrangement of eccentric sensors can be understood to mean an arrangement of the eccentric sensors in which an element placed on an eccentric passes over the eccentric sensor when the eccentric is rotated. Thus, further typical drive sensor positions can be assigned to slide sensor positions, which can represent, e.g. further typical transmission settings, e.g. “P.”

In order to avoid wear to the sensor system, it is advantageous when at least one drive sensor in the drive sensor system, and/or at least one slide sensor in the slide sensor system is at least partially in the form of a magnetic sensor. The drive unit and/or the slide unit can have at least one magnet for detecting the at least one dedicated position.

Because the drive unit can be an eccentric element, as stated above, the embodiments of the approach described below shall be described with a drive unit in the form of an eccentric element.

According to one embodiment, the slide unit of the release device is or can be coupled to the parking lock via a force transferring element, e.g. a cable pull, wherein the slide unit can be configured to place a locking position of the force transferring element in a parking lock position, in order to lock or engage the parking lock when the eccentric element is located in the first position, and in response to a movement of the eccentric element into the second position, to move into a released position, in which the slide unit places the force transferring element in a parking released position, in order to release or disengage the parking lock. The parking lock can thus be released purely mechanically in response to the movement of the eccentric element from the first position into the second position. This can take place with just one force transferring element already present in a shifting mechanism of the vehicle, e.g. the cable pull, wherein the parking lock can be released without electrical energy and manually. This may be advantageous when a broken down vehicle must be removed from where it is parked.

The release device can also have an actuator that is configured to move the eccentric element from the first position to the second position in response to an actuation. The actuator can be located on the gear selection lever or in the vicinity of the gear selection lever for this, for example, because the actuator is readily accessible to a user there.

A section of the eccentric element that is received in the slide unit can be configured to move linearly along an eccentric axle of the eccentric element in response to the actuation. The section can thus be moved along the eccentric axle from the first position to the second position. The section can be received in a through hole in the slide unit when the eccentric element is in the first position, and partially or completely removed from the through hole when the eccentric element is in the second position.

According to one embodiment, the section of the eccentric element can have an offset element, which is configured to limit a sideways movement of the slide unit in response to the linear movement of the eccentric element that is perpendicular to the linear movement, when the eccentric element according to one embodiment is also at least partially located in the slide unit in the second position. The offset element can advantageously form a step-shaped rise on the section, which is configured to limit the sideways movement of the slide unit in a form fitting manner when the eccentric element is in the second position. The slide unit can thus bear on the offset element when the eccentric element is in the second position.

In order to limit the movement of the eccentric element, e.g. the linear movement, the eccentric element, e.g. the eccentric axle, can have at least one compression spring, which is relaxed when the eccentric element is in the first position, and which is located such that it is tensioned in response to the actuation by at least one component of the eccentric element, e.g. by the section. Such a compression spring can also make it easier to move the component form the second position back to the first position.

The release device can have transport element according to an advantageous embodiment, that is configured to transport the slide unit from the locked position to the released position. The transport element can enable a gentle movement of the slide unit from the locked position to the released position, with which, e.g., wear to the offset element can be prevented. For this, the transport element has at least one supporting spring, which is located such that it exerts a tension on the slide unit and/or a lever of the transport element when the slide unit is in the locked position, wherein the supporting spring is located such that it releases the tension in response to the movement of the eccentric element into the second position, in order to enable a transfer of the slide unit into the released position.

It is also advantageous when the transport element also includes at least the lever, which can be configured to be shifted in response to a release of the tension in the supporting spring, in order to gently push the slide unit into the released position.

In order to prevent a movement of the slide unit from the locked position to the released position, as long as the eccentric element is in the first position, the transport element can have at least one hook assembly with at least one hook, which is coupled with the lever assembly when the eccentric element is in the first position, such that a returning of the lever assembly is prevented in a form fitting manner. The hook assembly can furthermore be configured such that it is deflected by the movement of the eccentric element into the second position, such that the hook releases the lever assembly, and the lever assembly is returned by the supporting spring.

It is also advantageous when the release device has at least one damping element, located on or in a housing for the release device, which is configured to at least dampen sounds from the release device, e.g. sounds occurring when releasing the parking lock. The damping element can have at least one hole for this, which can receive a dome of an adapter assembly, to which the release device is to be secured. In order to secure the release device to the adapter assembly, the damping element can have at least one self-threading screw, which is configured to be screwed into the dome of the adapter assembly when the damping element is received in the dome.

A method for registering a least one position of a drive unit in, or in the vicinity of, a slide unit in any of the release devices for a vehicle presented above comprises at least the following steps:

receiving a drive sensor signal and a slide sensor signal from the sensor system in the release device; and detecting the position of the drive unit in, or in the vicinity of, the slide unit, using the drive sensor signal and the slide sensor signal.

The fundamental advantages of the release device of the approach can also be implemented quickly and technically simply with the method presented herein.

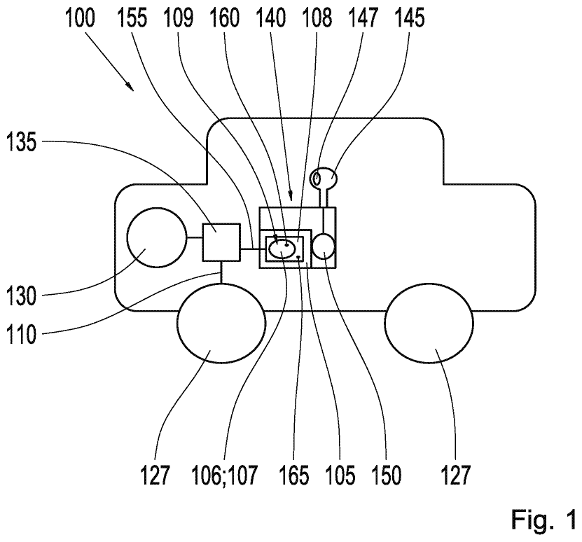

FIG. 1 shows a schematic illustration of a vehicle that has a release device according to an exemplary embodiment;

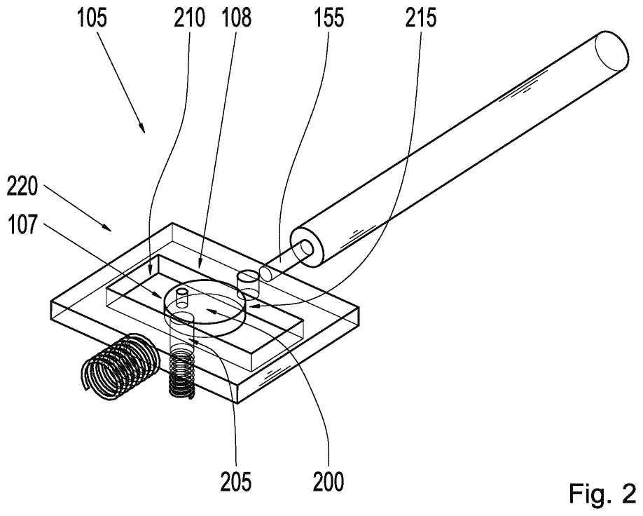

FIG. 2 shows a perspective view of a release device according to an exemplary embodiment;

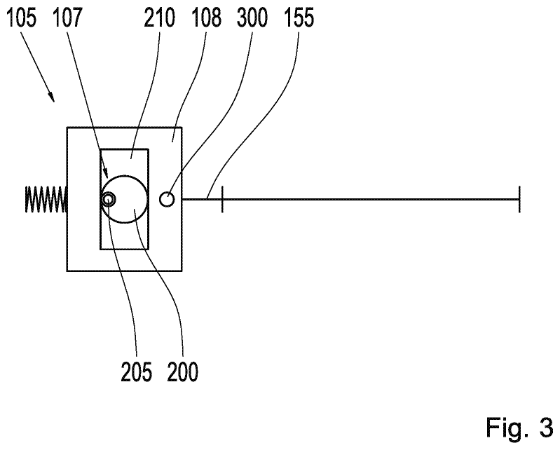

FIG. 3 shows a schematic top view of a release device according to an exemplary embodiment;

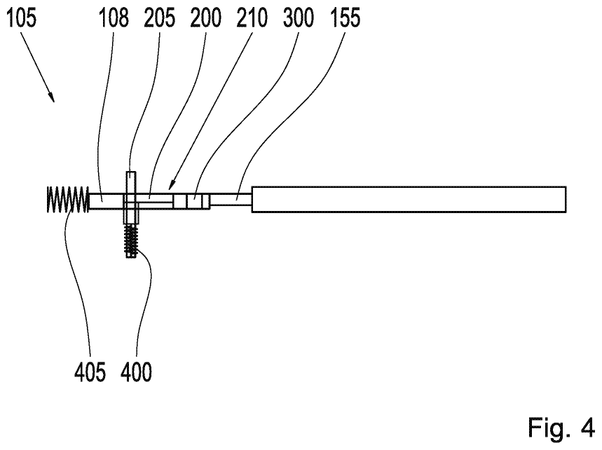

FIG. 4 shows a lateral cross section view of a release device according to an exemplary embodiment;

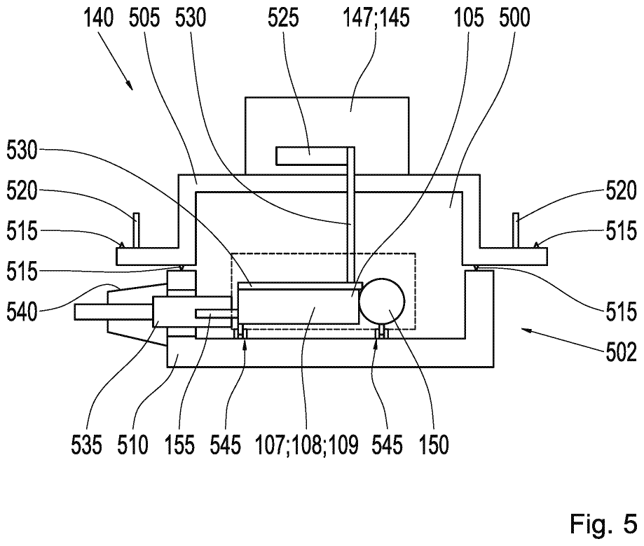

FIG. 5 shows a schematic cross section view of a shifting mechanism that has a release device according to an exemplary embodiment;

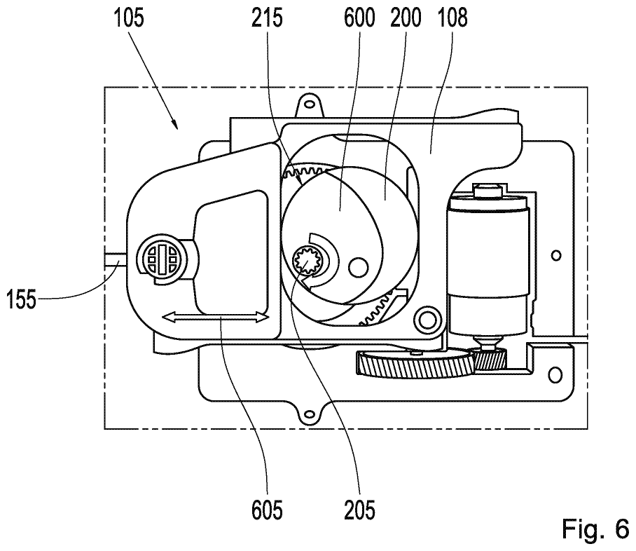

FIG. 6 shows a top view of a release device according to an exemplary embodiment;

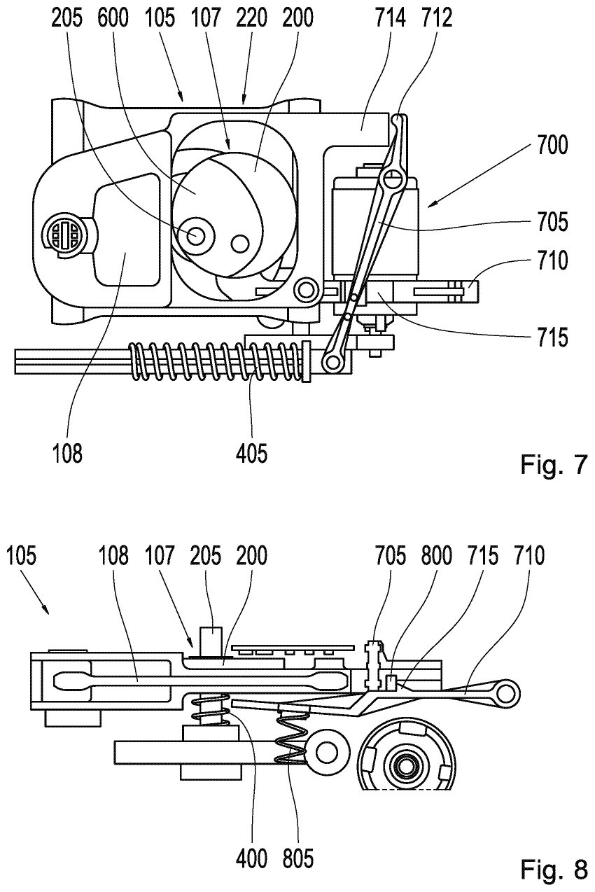

FIG. 7 shows a top view of a release device according to an exemplary embodiment;

FIG. 8 shows a lateral cross section view of a release device according to an exemplary embodiment;

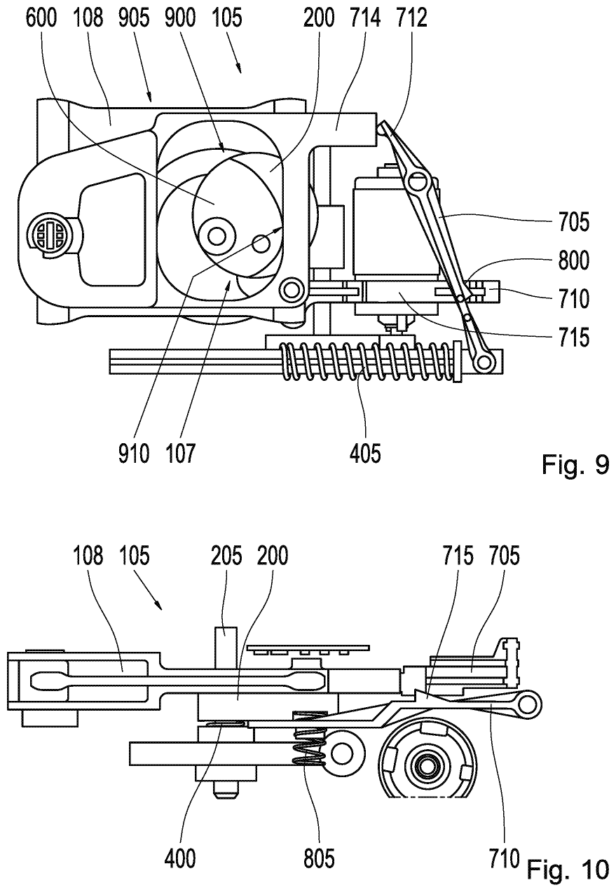

FIG. 9 shows a top view of a release device according to an exemplary embodiment;

FIG. 10 shows a lateral cross section view of a release device according to an exemplary embodiment;

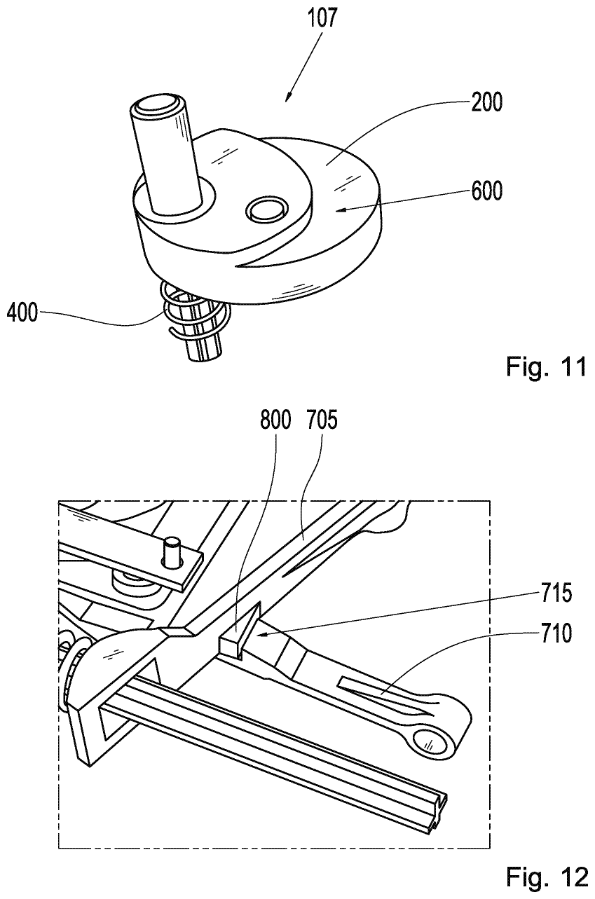

FIG. 11 shows a perspective illustration of an eccentric element that has an offset element according to an exemplary embodiment;

FIG. 12 shows a perspective top view of a hook assembly according to an exemplary embodiment;

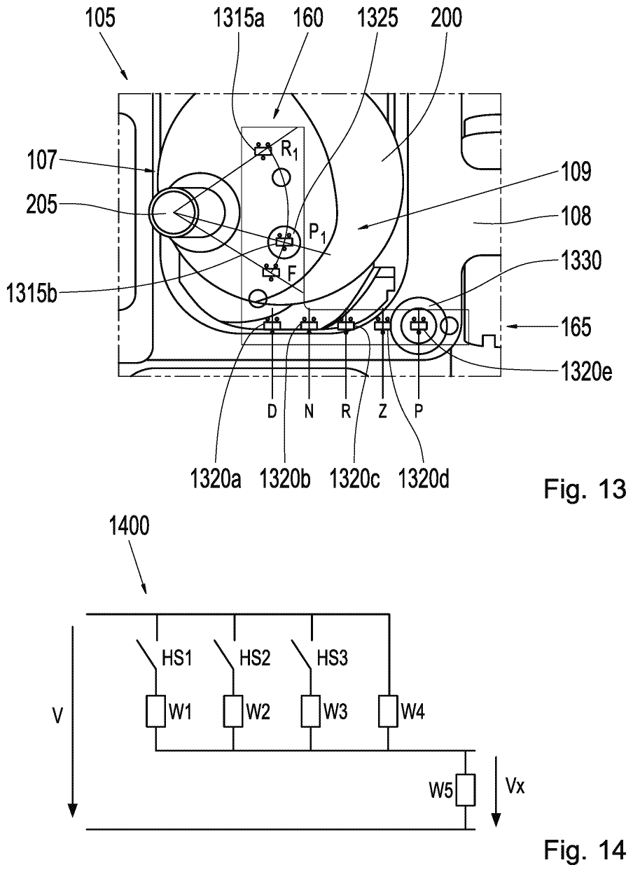

FIG. 13 shows a top view of a release device that has a sensor system according to an exemplary embodiment;

FIG. 14 shows an illustration of a circuitry of sensors according to an exemplary embodiment;

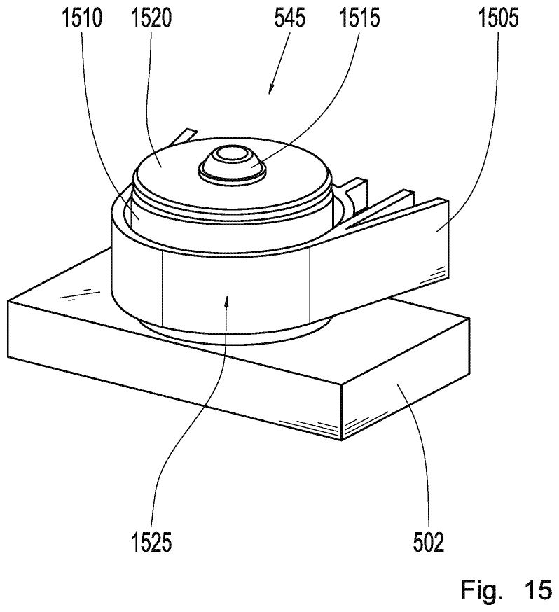

FIG. 15 shows a perspective view of a damping element according to an exemplary embodiment;

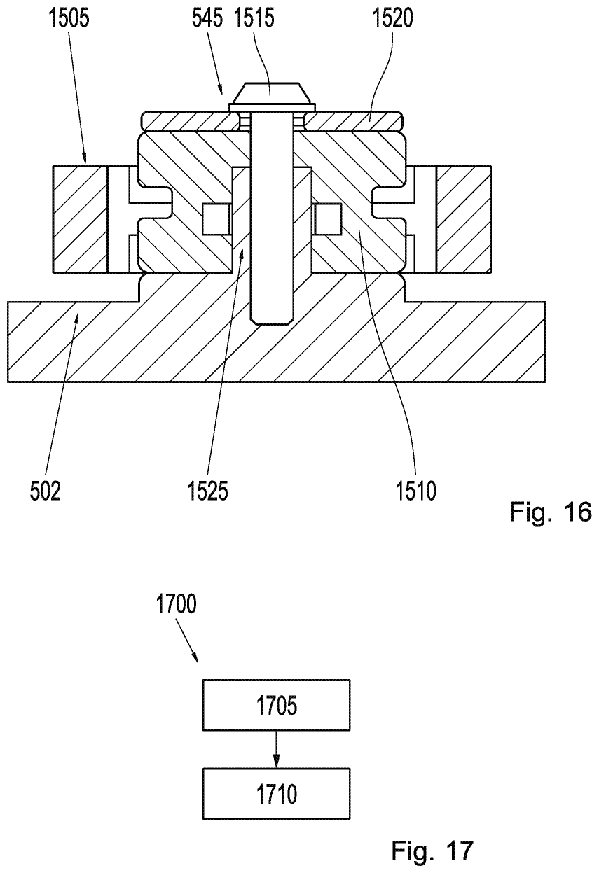

FIG. 16 shows a lateral cross section view of a damping element according to an exemplary embodiment; and

FIG. 17 shows a flow chart for a method for operating a release device according to an exemplary embodiment.

In the following description of preferred exemplary embodiments of the present approach, identical or similar reference symbols shall be used for the elements illustrated in the various figures that have similar functions, wherein there shall be no repetition of the descriptions of these elements.

FIG. 1 shows a schematic illustration of a vehicle 100 that has a release device 105 according to an exemplary embodiment. The release device 105 is configured to detect at least one position of a drive unit 106 in, or in the vicinity of, a slide unit 108. For this, the release device 105 comprises at least the drive unit 106, in the form of an eccentric element 107 according to this exemplary embodiment, the slide unit 108, and a sensor system 109.

According to this exemplary embodiment, the vehicle 100 has at least one parking lock 110, numerous wheels 127, an engine 130, a vehicle transmission 135 in the form of an automatic transmission according to this exemplary embodiment, and a shifting mechanism 140 with a gear selection lever 145 that has an actuator 147, in addition to the release device 105. According to this exemplary embodiment, the release device 105 is part of the shifting mechanism 140, wherein the release device 105 is received in an interior chamber in the shifting mechanism 140. The actuator 147 is optionally a part of the release device 105 according to this exemplary embodiment, and is located on the gear selection lever 145 of the shifting device 140, in order to be accessible to a driver of the vehicle 100 located in the vehicle 100. There is also a shifting mechanism motor 150 located in the interior of the shifting mechanism 140 according to this exemplary embodiment. The slide unit 108 of the release device 105 is coupled to the parking lock 110 via a force transferring element 155, e.g. a cable pull and the vehicle transmission 135.

The eccentric element 107 is at least partially located in the slide unit 108 of the release device 105 in a first position shown herein, in order to lock or engage the parking lock 110 of the vehicle 100, and at least partially removed from the slide unit 108 in a second position shown in FIGS. 9 and 10, in order to release or disengage the parking lock 110. The slide unit 108 at least partially receives the eccentric element 107 in the first position of the eccentric element 107 shown herein. The sensor system 109 has at least one drive sensor system 160 located on the eccentric element 107, and a slide sensor system 165 located on the slide unit 108, wherein the sensor system 109 is configured to at least detect the position of the eccentric element 107 received in the slide unit 108, or located in the vicinity of the slide unit 108. According to this exemplary embodiment, the position represents a position of the eccentric element 107 located in the second position.

According to this exemplary embodiment, the eccentric element 107 is configured to retain the slide unit 108 in a locked position when it is in the first position in which it is at least partially received in the slide unit 108, in which the parking lock 110 is locked, and to enable a transport of the slide unit 108 into a released position when in the second position, in which the parking lock 110 is released. The slide unit 108 is coupled to the parking lock 110 via a cable pull 155, and is configured to place the force transferring element 155, or cable pull, in a parking locked position when in the locked position, in order to lock or engage the parking lock 110, and to place the force transferring element 155, or cable pull, in a parking released position when in the released position, in order to release or disengage the parking lock 110. The actuator 147 is configured to move the eccentric element 107 from the first position to the second position in response to an actuation.

The approach described herein shall be explained in greater detail below:

With the increase in automated driving functions and electrified vehicles 100, electrically actuated parking locks 110 have become more prevalent. Shifting actuators for gear selection in vehicle transmissions 135, previously referred to as the gear selection lever 145, are located in the interior of the vehicle 100. There are various types of gear selection levers 145:

With manual shifting actuators, gear selection as well as engaging and disengaging the parking lock 110 are implemented via one or more force transferring elements 155, e.g. rods or cable pulls. In the following description, the approach presented herein shall be described using a cable pull as the force transferring element 155, regardless of whether it is clear to the person skilled in the art that an alternative force transferring element, e.g. a rod, can also be used as the force transferring element 155. Shifting actuators that have an electronic detection of the position of the gear selection lever 145 and mechanical actuation of the parking lock 110 are more conventional. Lastly, there are also fully electronic shifting actuators, which are increasingly used in modern vehicles 100. In these, both a position detection as well as a driver's desire to actuate the parking lock 110 are transferred electronically to the vehicle transmission 135, or to the release device 105, which can also be referred to as a parking lock actuator.

With vehicles 100 in which various shifting actuator concepts are implemented, it is necessary to obtain a modularity in the release device 105 as well. The release device 105 can be installed in numerous locations, e.g. the vehicle transmission 135, the engine compartment, or, as described herein, below the gear selection lever 145 located in the interior of the vehicle 100. According to this exemplary embodiment, the parking lock 110 is actuated via the pull cable 135. According to an alternative exemplary embodiment, the parking lock 110 can also be actuated via a rod. If the vehicle 100 has to be towed after breaking down, it is also necessary with all of the concepts described above to be able to release the parking lock 110 without electrical energy and manually. In order to still be able to secure the vehicle 100 via the brakes, when the vehicle 100 has be released for an emergency, the release device 105 is operated, which can also be referred to as an emergency release, from the interior of the vehicle 100 according to this exemplary embodiment, by actuating the actuator 147. For this, an additional cable pull is installed from the vehicle transmission to the vehicle interior in known vehicles, to which the release device is connected.

In differing from known release devices, in which an emergency release is installed separately in the interior, advantageously only one cable pull 155 is necessary in the release device 105 presented herein. An actuation of the release device 105 transfers vibrations and noises from the vehicle transmission 135 to the interior of the vehicle 100 via the cable pull 155, which may be disrupting. Because the release device 105 described herein only has one cable pull 155, the vibrations and noises only have to be decoupled once.

According to this exemplary embodiment, the release device 105 is installed beneath the gear selection lever 145 in the vehicle 100. The connection to the vehicle transmission 135 and thus to the parking lock 110 is obtained via the cable pull 155. The cable pull connection and the release device 105 are acoustically decoupled collectively, cf. FIGS. 5, 15, and 16. A transfer of the rotational movement generated in the release device 105 by the shifting mechanism motor 150 into the translational movement of the cable pull 155 is obtained through the eccentric element 107. In other words, a rotational movement of the gearing of the shifting mechanism motor 150 is converted by means of the eccentric element 107 to a linear movement of the slide unit 108, which can also be referred to as a cable pull slide.

FIG. 2 shows a perspective view of a release device according to an exemplary embodiment. This can be the release device 105 described in reference to FIG. 1. The sensor system belonging to the release device 105 described in FIG. 1 is not shown in this exemplary embodiment, and shall be described in greater detail in reference to FIG. 13.

According to this exemplary embodiment, the eccentric element 107 has a circular section 200 and an eccentric axle 205, which extends perpendicular to a plane of the section 200. The slide unit 108 is rectangular according to this exemplary embodiment, and has a rectangular through hole 210 in the middle, which can also be referred to as a gate opening. According to this embodiment, the section 200 is received entirely in the slide unit 108 when the eccentric element 107 is the first position 215 shown here, in the through hole 210 of the slide unit 108 according to this embodiment. The slide unit 108 is thus in the locked position 220.

FIG. 3 shows a schematic top view of a release device 105 according to an exemplary embodiment. This can be the release device 105 described in reference to FIG. 2. According to this exemplary embodiment, the slide unit 108 has a receiving unit 300, which is designed to receive the cable pull 155.

FIG. 4 shows a lateral cross section view of a release device 105 according to an exemplary embodiment. This can be the release device 105 described in reference to FIG. 3.

It should be noted that in FIG. 4, the eccentric element 205 passes through the section 200, and extends at two sides of the plane of the section 200. The release device 105 has a compression spring 400 and supporting spring 405 according to this exemplary embodiment. The compression spring 400 encircles a subsection of the eccentric element 205, and is relaxed in the first position of the eccentric element shown here. According to this exemplary embodiment, the section 200 is configured to execute the linear movement along the eccentric axle 205 toward the compression spring 400 in response to the actuation, in order to tension the compression spring 400. The supporting spring 405 is perpendicular to the compression spring 400 according to this exemplary embodiment, and exerts a tension on the slide unit 108, as long as the section 200 is located in the first position. When the section 200 fully exits the through hole 210 toward the compression spring 400 in response to the actuation, the slide unit 108 executes a sideways movement perpendicular to the linear movement, driven by the supporting spring 405, according to this exemplary embodiment.

The release device 105 shall be explained in greater detail below. The emergency disengagement of the parking lock enabled by the release device 105 is implemented as follows: The disengagement procedure is supported by the transport spring 405. The spring force of the transport spring 405 is such that it is capable of disengaging the parking brake. The section 200 of the eccentric element can be displaced axially, and is retained in the nominal position via the compression spring 400 located beneath it. In order to release the parking lock, the section 200 of the eccentric element is pushed out of the through hole 210, which can also be referred to as a gate opening, when in the position “P,” and the slide unit 108 can then slide, driven by the supporting spring 405. The parking lock applied to the sliding unit 108 is thus disengaged via the cable pull 155. The subsequent re-engagement of the parking lock is obtained through an initialization run of the release device 105, which can be initiated in the factory, or when replacing the fuel filter. The displacement of the eccentric axle 205 is obtained by a button in the form of an actuator, which is attached to the shifting mechanism in an acoustically decoupled manner, e.g. to the gear selection lever according to this exemplary embodiment, or to an adapter assembly shown in FIG. 5 according to an alternative exemplary embodiment. The acoustic decoupling is obtained via an air gap.

FIG. 5 shows a schematic cross section view of a shifting mechanism 140 with a release device 105 according to an exemplary embodiment. This can be the shifting mechanism 140 described in reference to FIG. 1, with a release device 105 described in reference to FIGS. 1 to 4. The interior 500 of the shifting mechanism 140 is encompassed by an adapter assembly 502 according to this exemplary embodiment, which has an adapter 505 and a cover 510. The shifting mechanism 140 according to this exemplary embodiment has numerous seals 515 between the adapter 505 and the cover 510, as well as in the vicinity of the ends of the adapter 505. The adapter assembly 502 according to this exemplary embodiment also has numerous studs 520 in the vicinity of the seals 515 in the vicinity of the ends of the adapter 505, which serve as customer interfaces. The gear selection lever 145, which can also be referred to as a gearshift lever, has control electronics 525. A flex foil 530 for establishing contact to the release device 105 is located between the control electronics 525 and the part of the release device 105 located in the interior 500 according to this exemplary embodiment, wherein the flex foil 530 has sensors for this. The cable pull 155 is partially encased by an initial tube 535 according to this exemplary embodiment. In a region in which the cable pull 155 and the initial tube 535 pass through the cover 510, the shifting mechanism 140 has a sealing sleeve 540, which bears on the outside of the cover 510, and encompasses the initial tube 535 in a sealing manner. There are two damping elements 545 located between the release device 105 and the cover 510 according to this exemplary embodiment, which are configured to dampen the sounds caused by releasing the parking lock.

FIG. 6 shows a top view of a release device 105 according to an exemplary embodiment. This can be the release device 105 described in reference to FIG. 4. According to this exemplary embodiment, the section 200 of the eccentric element 107 has an offset element 600, which is configured to limit the sideways movement 605 of the slide unit 108 perpendicular to a linear movement of the eccentric element 107 in response to said linear movement, when the eccentric element 107 has executed the linear movement, as shown in FIG. 9, and is located in the second position. For this, the offset element 600 forms a step-like rise in the section 200.

FIG. 7 shows a top view of a release device 105 according to an exemplary embodiment. This can be the release device 105 described in reference to FIG. 6, with the difference that the release device 105 according to this exemplary embodiment has a transport element 700, which is configured to transport the slide unit 108 from the locked position 220 to the released position shown in FIG. 9. The transport element 700 contains the supporting spring 405 for this, and, according to this exemplary embodiment, also has a lever assembly 705 and a hook assembly 710.

The supporting spring 405 exerts a tension on the lever assembly 705 of the transport element 700 when the slide unit 108 is in the locked position 220, wherein the supporting spring 405 releases the tension in response to a movement of the eccentric element 107 into the second position, in order to be able to move the slide unit 108 into the released position.

The lever assembly 705 is configured to be tilted back in response to a release of the tension in the supporting spring 405, in order to push the slide unit 108 into the released position. For this, the lever assembly 705 has a lug 712 according to this exemplary embodiment, which bears on a projection 714 on the slide unit 108.

The hook assembly 710 has at least one hook 715, which is coupled to the lever assembly 705 when the eccentric element 107 is in the first position, shown here, which prevents a tilting back by the lever assembly 705. The hook assembly 710 is furthermore deflected by the eccentric element 107 when the eccentric element 107 moves into the second position, such that the hook 715 releases the lever assembly 705, and the lever assembly 705 is tilted back by the force of the supporting spring 405.

An emergency release via an offset can be seen in FIG. 7. An eccentric shaft of the eccentric axle 205 can be displaced axially. When the parking lock is released, the eccentric element 107/eccentric shaft is displaced linearly in the direction of its axis. The section 200 of the eccentric element 107 has a two-step design, obtained with the offset element 600. The offset element serves as a limit for the movement of the slide device 108, which is actuated via the transport spring 405, which can also be referred to as an emergency release spring, and the lever assembly 705, which can also be referred to as a transport lever.

FIG. 8 shows a lateral cross section view of a release device 105 according to an exemplary embodiment. This can be the release device 105 described in reference to FIG. 7. It can be seen in FIG. 8 that the hook 715 bears on a surface 800 of the lever assembly 705, and thus prevents a tilting back of the lever assembly 705 in a form fitting manner, when the eccentric element 107 is in the first position. The hook assembly 710 has a hook assembly spring 805 according to this exemplary embodiment.

FIG. 9 shows a top view of a release device 105 according to an exemplary embodiment. This can be the release device 105 described in reference to FIG. 8, with the difference that the eccentric element 108 is moved by the actuation into the second position 900, and the slide unit 108 moves to the released position 905 in response thereto, by means of which the parking lock is released. The hook 715 is pushed away from the surface 800 by the linear movement of the section 200, by means of which the lever assembly 705 is tilted back by the transport spring 405, and the slide unit 108 is pushed into the released position 905 with the lug 712 pressing on the projection 714. When in the released position, the slide unit 108 has executed the sideways movement, and then bears with an edge 910 of the through hole on a side of the offset element 600.

In other words, the parking lock is released via the transport spring 405 in this exemplary embodiment. The energy stored in the tensioned transport spring 405 is transferred to the slide unit 108 via the lever assembly 705. The transport spring 405 is re-tensioned via the motor, the transmission, and the eccentric element 107 or via another mechanical element, e.g. an external lever.

FIG. 10 shows a lateral cross section view of a release device 105 according to an exemplary embodiment. This can be the release device 105 described in reference to FIG. 9. It can be seen in FIG. 10 that the section 200 has pushed the hook assembly 710 away from the lever assembly 705 through the linear movement, such that the hook 715 is moved away from the surface, and the lever assembly 705 can thus be tilted back.

FIG. 11 shows a perspective illustration of an eccentric element 107 with an offset element 600 according to an exemplary embodiment. This can be the eccentric element 107 described in reference to FIGS. 6 to 10.

FIG. 12 shows a perspective top view of a hook assembly 710 according to an exemplary embodiment. This can be the hook assembly 710 described in reference either FIG. 7 or FIG. 8, in which the hook 715 bears on the surface 800 of the lever assembly 705, and thus prevents a tilting back of the lever assembly 705 in a form fitting manner, when the eccentric element is in the first position.

In normal operation, thus when the parking lock is not released by the release device, the emergency release is secured as follows:

In any of the normal operating modes P R N D, the transport spring 405 or the lever assembly 705 is secured in place after tensioning via a locking mechanism, e.g. a mechanically secured locking latch, such as the hook assembly 710 shown here, and/or a locking lever via a magnetic clamp and/or a locking magnet, by means of which a permanent load to the motor, transmission, eccentric element and slide unit 108 is prevented.

In the operating modes N and D, the eccentric element is secured as follows: In positions N and D, the linear movement of the eccentric element/eccentric shaft is prevented, in order to avoid an unintentional actuation of the release device, e.g. through vibrational loads. A bearing is divided into three regions for this: a torque region, a load region, and a cover.

FIG. 13 shows a top view of a release device 105 with a sensor system 109 according to an exemplary embodiment. The release device 105 can be any of the release devices 105 described in reference to the preceding figures. As stated in reference to FIG. 1, the sensor system 109 is configured to detect a position of an eccentric element 107 received in the slide unit 108, or located in the vicinity of the slide unit 108. According to this exemplary embodiment, the sensor system 109 is configured to detect a position of the eccentric element 107, which represents a location of the eccentric element 107 in the second position, in order to register a parking lock release by the release device 105. According to this exemplary embodiment, however, the eccentric element 107 is located in the first position. The sensor system 109 includes the drive sensor system 160 located on the eccentric element 107, and the slide sensor system 165 located on the slide unit 108.

According to this exemplary embodiment, the sensor system 109 is configured to detect the position by comparing a position of a drive sensor 1315 in the drive sensor system 160 and a position of a slide sensor 1320 in the slide sensor system 165. According to this exemplary embodiment, the drive sensor system 160 has numerous drive sensors 1315a; 1315b, which are arranged in a curve on the section 200 surrounding the eccentric axle 205, and the slide sensor system 165 has numerous slide sensors 1320a; 1320b; 1320c; 1320d; 1320e, which are arranged linearly. According to this exemplary embodiment, at least one position of a drive sensor 1315 in the drive sensor system 160 is assigned to a position of a slide sensor 1320 in the slide sensor system 165, wherein the position is detected when the drive sensor position is not located in a predefined relationship to the slide sensor position assigned thereto. According to this exemplary embodiment, the position of the drive sensor 1315a is assigned to the position of the slide sensor 1320c, corresponding to a gear selection lever position in the R setting. According to this exemplary embodiment, the position of the drive sensor 1315b is assigned to the position of the slide sensor 1320e, corresponding to a gear selection lever position in the P setting. According to this exemplary embodiment, a position of a drive sensor 1315 is located in relationship to a position of one of the slide sensors 1320, such that the position is not detected by the sensor system 109 according to this exemplary embodiment.

According to this exemplary embodiment, the drive sensors 1315a; 1315b and the slide sensors 1320a; 1320b; 1320c; 1320d; 1320e are formed at least in part as magnetic sensors. According to an alternative exemplary embodiment, at least one of the drive sensors 1315 and/or one of the slide sensors 1320 is formed at least in part as a magnetic sensor. In order to detect the at least one assigned position, the drive sensor system 160 has an eccentric magnet 1325 and the slide sensor system 165 has a slide magnet 1330.

In the sensor concept presented herein, there are damping elements for the sensor system formed by the slide sensor system 165 and the drive sensor system 160 on both the slide unit 108 as well as the eccentric element 107.

Redundancies for settings P and R: The emergency function is detected according to this exemplary embodiment by the drive sensors 1315 on the eccentric element 107, when there is no signal. The normal functioning is detected by the drive sensors 1315/drive sensor 1315a on the eccentric element 107. A spring position F is for shutting off the motor when executing the procedure “tension spring.”

FIG. 14 shows an illustration of a circuitry 1400 of sensors according to an exemplary embodiment. This can be a circuitry 1400 of the slide sensors and drive sensors described in reference to FIG. 13.

FIG. 15 shows a perspective view of a damping element 545 according to an exemplary embodiment. This can be the damping element 545 described in reference to FIG. 5. The damping element 545 is configured to acoustically dampen at least one sound made by the release device described in reference to any of the FIG. 1 to 10 or 13 when the parking lock is released. The damping element 545 is part of the release device according to this exemplary embodiment, and located between a housing 1505 for the release device and the adapter assembly 502 for the shifting mechanism described in reference to FIG. 5. According to this embodiment, the damping element 545 has a damper body 1510 with an opening, a self-threading screw 1515, and a washer 1520.

The opening receives a dome 1525 of the adapter assembly. The self-threading screw 1515 is screwed into the dome 1525 of the adapter assembly 502, in order to secure the housing 1505 for the release device to the adapter assembly 502. According to this exemplary embodiment, the damping element 545 is received in an annular section of the housing 1505.

The damping element 545 enables an acoustic encapsulation under a base plate in the module. The release device is located beneath the base plate in the adapter assembly 502, and is acoustically decoupled, in order to prevent noises. The decoupling takes place via numerous damping elements 545, which prevent the transmission of vibrations between the release device and the adapter assembly 502. In differing from known release devices, a self-threading screw 1515 for plastic is advantageously used with the damping element 545 presented herein. This is screwed into an injection molded dome 1525, which is located on the adapter assembly 502 screwed to the release device.

FIG. 16 shows a lateral cross section view of a damping element 545 according to an exemplary embodiment. This can be the damping element 545 described in reference to FIG. 15.

FIG. 17 shows a flow chart for a method 1700 for registering at least one position of a drive unit in, or in the vicinity of, a slide unit in a release device according to an exemplary embodiment. This can be a method for registering the at least one position of a drive unit in, or in the vicinity of, a slide unit in any of the release devices described in reference to any of the FIG. 1 to 10 or 13. The method 1700 comprises at least one step 1705 for receiving, and one step 1710 for detecting. In the receiving step 1705, a drive sensor signal and a slide sensor signal are received from the sensor system in the release device. In the detecting step 1710, the position of the drive unit in, or in the vicinity of, the slide unit is detected by means of the drive sensor signal and the slide sensor signal.

The exemplary embodiments described herein and shown in the figures are selected merely by way of example. Different exemplary embodiments can be combined with one another, either in their entireties or with respect to individual features. Furthermore, one exemplary embodiment can be supplemented by features of another exemplary embodiment.

Moreover, method steps can be repeated, or executed in a different order than that in the sequence described herein.

If an exemplary embodiment comprises an “and/or” conjunction between a first feature and a second feature, this can be read to mean that the exemplary embodiment according to one embodiment contains both the first feature and the second feature, and according to another embodiment, contains either just the first feature, or just the second feature.

Reference Symbols

100 vehicle

105 release device

106 drive unit

107 eccentric element

108 slide unit

109 sensor system

110 parking lock

127 wheel

130 motor

135 vehicle transmission

140 shifting mechanism

145 gear selection lever

147 actuator

150 shifting mechanism motor

155 cable pull

160 drive sensor system

165 slide sensor system

200 section

205 eccentric axle

210 through hole

215 first position

220 locked position

300 receiving unit

400 compression spring

405 supporting spring

500 interior

502 adapter assembly

505 adapter

510 cover

515 seal

520 stud

525 control electronics

530 flex foil

535 initial tube

540 sealing sleeve

545 damping element

600 offset element

605 sideways movement

700 transport element

705 lever assembly

710 hook assembly

712 lug

714 projection

715 hook

800 surface

805 hook assembly spring

900 second position

905 released position

910 edge

1315 drive sensor

1315a drive sensor

1315b drive sensor

1320 slide sensor

1320a slide sensor

1320b slide sensor

1320c slide sensor

1320d slide sensor

1320e slide sensor

1325 eccentric magnet

1330 slide magnet

1400 circuitry

1505 housing

1510 damper body

1515 self-threading screw

1520 washer

1525 dome

1700 method

1705 moving step

1710 translating step

1. A release device for a vehicle for detecting at least one position of a drive unit in, or in the vicinity of, a slide unit, wherein the release device has at least the following features:
the drive unit, which is or can be located at least in part in the slide unit of the release device in a first position, in order to lock or engage a parking lock of the vehicle, and which is at least partially removed from the slide unit in a second position, in order to release or disengage the parking lock;
the slide unit, configured to at least partially receive the drive unit in the first position; and
a sensor system, which has at least one drive sensor system located on the drive unit, and/or one slide sensor system located on the slide unit, wherein the sensor system is configured to detect the position of the drive unit received in the slide unit or located in the vicinity of the slide unit.

2. The release device according to claim 1, in which the sensor system is configured to compare a position of a drive sensor in the drive sensor system and/or a position of a slide sensor in the slide sensor system, in order to detect the position.

3. The release device according to claim 1, in which the drive sensor system has numerous drive sensors, which are arranged in a curve, and/or the slide sensor system has numerous slide sensors arranged linearly.

4. The release device according to claim 1, in which at least one position of a drive sensor in the drive sensor system is assigned to a position of a slide sensor in the slide sensor system, in particular wherein the position is detected when the drive sensor position is not located in a predefined relationship to the slide sensor position assigned thereto.

5. The release device according to claim 1, in which at least one drive sensor of the drive sensor system, and/or one slide sensor of the slide sensor system is formed at least in part as a magnetic sensor.

6. The release device according to claim 1, in which the drive unit is in the form of an eccentric element.

7. The release device according to claim 6, in which the slide unit is or can be coupled to the parking lock via a force transferring element, in particular a cable pull, wherein the slide unit is also configured to position a locking position of the force transferring element in a parking lock position, in order to lock or engage the parking lock, when the eccentric element is in the first position, and to transfer it to a released position in response to a movement of the eccentric element into the second position, in which the slide unit places the force transferring element in a parking release position, in order to release or disengage the parking lock.

8. The release device according to claim 6, which has an actuator that is configured to move the eccentric element from the first position to the second position in response to an actuation.

9. The release device according to claim 8, in which a section of the eccentric element received in the slide unit is configured to execute a linear movement along an eccentric axle of the eccentric element in response to the actuation.

10. The release device according to claim 9, in which the section of the eccentric element has an offset element, which is configured to limit a sideways movement of the slide unit that is perpendicular to the linear movement of the eccentric element in response to the linear movement.

11. The release device according to claim 8, in which the eccentric element has at least one compression spring, which is relaxed when the eccentric element is in the first position, and is located such that it is tensioned in response to the actuation by at least one component of the eccentric element.

12. The release device according to claim 7, which has a transport element that is configured to move the slide unit from the locked position to the released position, wherein the transport element has at least one supporting spring, which exerts a tension on the slide unit and/or a lever assembly in the transport element when the slide unit is in the locked position, wherein the supporting spring enables a release of the tension in response to the movement of the eccentric element into the second position, in order to transfer the slide unit into the released position.

13. The release device according to claim 12, in which the transport element includes at least the lever assembly, which is tilted back in response to a release of the tension in the supporting spring, in order to push the slide unit into the released position.

14. The release device according to claim 12, in which the transport element includes at least one hook assembly that has at least one hook, which is coupled to the lever assembly when the eccentric element is in the first position, such that the lever assembly is prevented from tilting back, wherein the hook assembly is deflected by the movement of the eccentric element into the second position, such that the hook releases the lever assembly and the lever assembly is tilted back by the supporting spring.

15. The release device according to claim 1, further comprising at least one damping element, which is configured to acoustically dampen at least one noise from the release device, wherein the damping element has at least one opening that is configured to receive a dome of an adapter assembly, wherein the damping element has at least one self-threading screw, which is screwed into the dome of the adapter assembly in order to secure the release device to the adapter assembly when the damping element is received in the dome.

16. A method for registering at least one position of a drive unit in, or in the vicinity of, a slide unit in a release device of a vehicle according to any of the preceding claims, wherein the method comprises at least the following steps:
receiving a drive sensor signal and a slide sensor signal from the sensor system in the release device; and
detecting the position of the drive unit in, or in the vicinity of, the slide unit by means of the drive sensor signal and the slide sensor signal.
